(19) United States
(12) Patent Application Publication
(10) Pub. No.: US 2015/0346038 A1
(43) Pub. Date: Dec. 3, 2015

(54) SEMICONDUCTOR APPARATUS

(71) Applicant: TOYOTA JIDOSHA KABUSHIKI KAISHA, Toyota-shi (JP)

(72) Inventor: Yosuke OSANAI, Toyota-shi (JP)

(21) Appl. No.: 14/684,631

(22) Filed: Apr. 13, 2015

(30) Foreign Application Priority Data
Jun. 2, 2014 (JP) 2014-114209

(51) Int. Cl. G01K 7/01

(52) U.S. Cl. CPC G01K 7/01

(57) ABSTRACT

A semiconductor apparatus includes a switching device; a first reflux diode connected in reverse parallel with the switching device; a current path connected in parallel with the first reflux diode; a second reflux diode inserted into the current path in series; and a temperature detection part configured to detect a temperature based on a differential voltage between a forward voltage of the first reflux diode and a forward voltage of the second reflux diode. A current density of the first reflux diode and a current density of the second reflux diode are different from one another.

### BACKGROUND OF THE INVENTION

1. Field of the Invention

The present invention relates to a semiconductor apparatus.

2. Description of the Related Art

A semiconductor apparatus is known where a temperature of an Insulated Gate Bipolar Transistor (IGBT) is monitored using temperature dependency of the forward voltage of a diode (for example, see Japanese Laid-Open Patent Application No. 2013-183595). In this semiconductor apparatus, the temperature of the IGBT with which a reflux diode is connected in reverse parallel is monitored as a result of the forward voltage of a temperature detecting diode installed on the same chip as the IGBT being detected.

### SUMMARY OF THE INVENTION

According to an aspect of the present invention, a semiconductor apparatus includes a switching device; a first reflux diode connected in reverse parallel with the switching device; a current path connected in parallel with the first reflux diode; a second reflux diode inserted into the current path in series; and a temperature detection part configured to detect a temperature based on a differential voltage between a forward voltage of the first reflux diode and a forward voltage of the second reflux diode. A current density of the first reflux diode and a current density of the second reflux diode are different from one another.

Other objects, features and advantages of the present invention will become more apparent from the following detailed description when read in conjunction with the accompanying drawings.

### BRIEF DESCRIPTION OF THE DRAWINGS

FIG. 1 illustrates a configuration of one example of a semiconductor apparatus;

FIG. 2 illustrates one example of temperature dependency of the forward voltage of a diode;

FIG. 3 illustrates one example of temperature dependency of the forward voltage difference between diodes having different current densities;

FIG. 4 illustrates a configuration of another example of a semiconductor apparatus;

FIG. 5 illustrates a configuration of one example of a power conversion apparatus including a plurality of semiconductor apparatuses;

FIG. 6 illustrates a configuration of yet another example of a semiconductor apparatus; and

FIG. 7 illustrates a configuration of another example of a power conversion apparatus including a plurality of semiconductor apparatuses.

### DETAILED DESCRIPTION OF THE EMBODIMENTS

In the related art described above, a reflux diode connected in reverse parallel with a switching device such as an IGBT is a sort of a heat generation source. Therefore, in the related art where the forward voltage of the temperature detecting diode separate from the reflux diode is detected, the temperature detecting accuracy may be degraded because time is required for transmitting heat from the reflux diode to the temperature detecting diode.

Further, the temperature dependency of the forward voltage of a diode is degraded more as the current density of the diode is greater. Therefore, the temperature detection accuracy may be degraded depending on the current density of the reflux diode when the temperature is detected through detection of the forward voltage of the reflux diode connected in reverse parallel with the switching device.

An object of the embodiments is to provide semiconductor apparatuses in where it is possible to detect a temperature with high accuracy.

Below, the embodiments of the present invention will be described using the drawings.

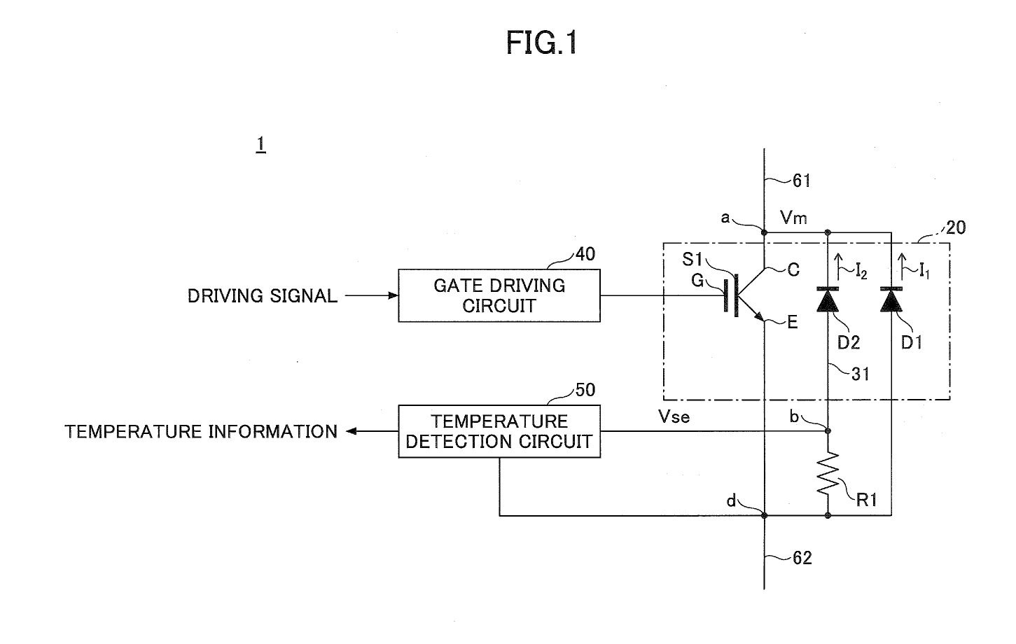

FIG. 1 illustrates a configuration of a driving apparatus that is one example of a semiconductor apparatus. The driving apparatus includes a transistor S1, a first diode D1, a path 31, a second diode D2 and a temperature detection circuit 50.

The transistor S1 is one example of a switching device. The first diode D1 is one example of a first reflux diode connected in reverse parallel with the transistor S1. The path 31 is one example of a current path connected in parallel with the first diode D1. The second diode D2 is one example of a second reflux diode inserted into the path 31 in series. The temperature detection circuit 50 is one example of a temperature detection part configured to detect a temperature based on the differential voltage ΔVF between the forward voltage VF1 of the first diode D1 and the forward voltage VF2 of the second diode D2.

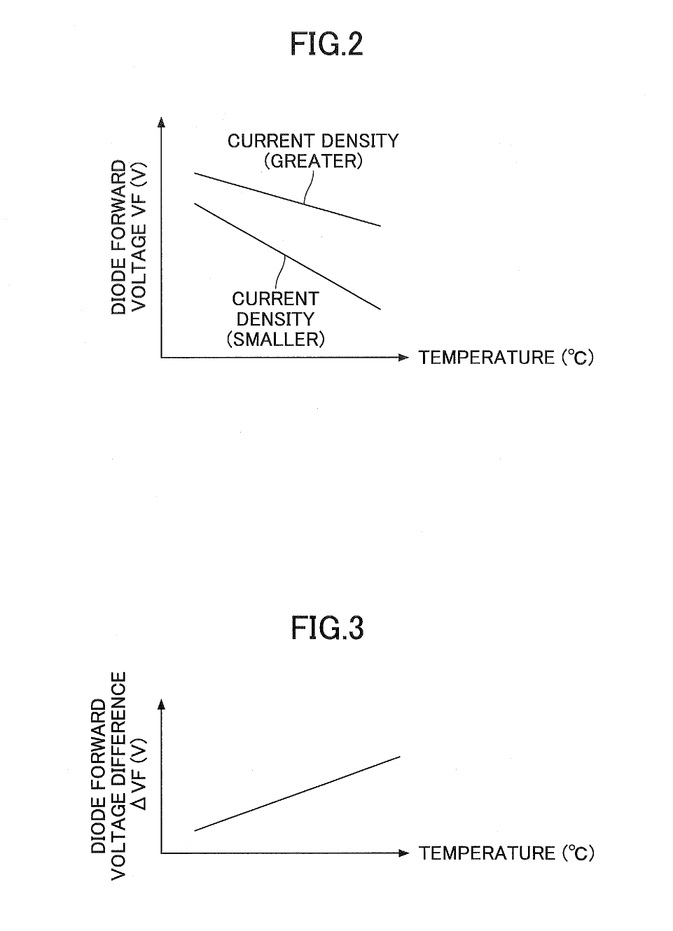

FIG. 2 illustrates one example of temperature dependency of the forward voltage VF of a diode. When a current flows through a diode, the forward voltage VF is generated between the anode and the cathode of the diode. The forward voltage VF of the diode has negative temperature characteristics where it falls as the temperature increases. Also, the temperature dependency of the forward voltage VF is such as to be reduced as the current density becomes greater. In other words, as shown in FIG. 2, the forward voltage VF at the greater current density does not easily fall even when the temperature increases, in comparison to the smaller current density.

Therefore, as shown in FIG. 2, the differential voltage between the forward voltage of the diode having the greater current density and the forward voltage of the diode having the smaller current density gradually increases as the temperature increases. In other words, the differential voltage ΔVF between the forward voltage of the diode having the greater current density and the forward voltage of the diode having the smaller current density has positive temperature characteristics where, as shown in FIG. 3, it increases proportionally as the temperature increases.

Therefore, in the driving apparatus of FIG. 1, the current density of the second diode D2 is set smaller than the current density of the first diode D1. Even in a condition where the temperature is relatively high, the temperature detection circuit 50 is capable of detecting the temperature with high accuracy based on the differential voltage ΔVF between the forward voltage VF1 of the first diode D1 and the forward voltage VF2 of the second diode D2.

Further, both the first diode D1 and the second diode D2 are reflux diodes where the reflux current (the forward current) flows during the turned-off period of the transistor S1. Therefore, the first diode D1 and the second diode D2 are heat generation sources themselves where large heat losses are generated due to the forward voltages and the forward currents. Therefore, by using the forward voltages (in other words, the forward voltage VF1 of the first diode D1 and the forward voltage VF2 of the second diode D2) of the heat generation sources themselves to detect the temperature, it is possible to avoid degradation in the temperature detection accuracy otherwise being degraded due to a heat transmission delay. Thus, it is possible to improve the temperature detection accuracy.

Further, the first diode D1 and the second diode D2 have both the function of flowing the reflux currents and the function of detecting the temperature. Therefore, in comparison to a case of providing diodes specially for detecting the temperature separate from reflux diodes, it is possible to miniaturize and reduce the cost of the driving apparatus 1.

Further, as a result of the first diode D1 and the second diode D2 being installed on a chip 20 on which the transistor S1 is installed, it is possible to detect the temperature of the transistor S1 installed on the same chip as the first diode D1 and the second diode D2 with high accuracy.

Next, the configuration of FIG. 1 will be described in more detail.

The driving apparatus 1 is, for example, a semiconductor circuit that drives an inductive load (for example, an inductor, a motor or so) connected between a first conductive part 61 and a second conductive part 62 by driving the transistor S1 in a manner of turning it on and turning it off.

The conductive part 61 is a current path conductively connected to, for example, a higher electric potential power source part such as the positive electrode of a power source, and can be connected to the higher electric potential power source part indirectly via another switching device or load. The conductive part 62 is a current path conductively connected to, for example, a lower electric potential power source part such as the negative electrode of the power source (for example, a ground electric potential part), and can be connected to the lower electric potential power source part indirectly via another switching device or load.

As an apparatus where one of more of the driving apparatuses are used, a power conversion apparatus, for example, can be cited where, through driving the transistor S1 in a manner of turning it on and turning it off, power is converted between an input and an output. As specific examples of the power conversion apparatus, a converter that boosts or steps down direct-current power, an inverter that converts power between direct-current power and alternate-current power, and so forth, can be cited.

The transistor S1 is, for example, an IGBT having the gate terminal G, the collector terminal C and the emitter terminal E. The gate terminal G is, for example, a control terminal connected to a gate driving circuit 40. The collector terminal C is, for example, a first main terminal connected to a connection point “a”, and connected to the conductive part 61 via the connection point “a”. The emitter terminal E is, for example, a second main terminal connected to a connection point “d”, and connected to the conductive part 62 via the connection point “d”.

The first diode D1 is a rectifying device having the anode connected to the emitter terminal E and the cathode connected to the collector terminal C, for example. The anode of the first diode D1 is a p-type electrode that is connected to the connection point “d” to which the emitter terminal E is connected and is connected to the conductive part 62 via the connection point “d”. The cathode of the first diode D1 is an n-type electrode that is connected to the connection point “a” to which the collector terminal C is connected, and is connected to the conductive part 61 via the connection point “a”.

The path 31 is, for example, a current path having one end that is connected to the connection point “d” and is connected to the conductive part 62 via the connection point “d”, and the other end that is connected to the connection point “a” and is connected to the conductive part 61 via the connection point “a”.

The second diode D2 is, for example, a rectifying device having the anode that is connected to the voltage detection part of the temperature detection circuit 50 via a connection point “b” and the cathode that is connected to the collector terminal C via the connection point “a”.

The driving apparatus 1 includes, for example, a resistor R1 inserted into the path 31 in series. Thereby, during a turned-off period of the transistor S1, the current value of a current I₂ refluxed from the conductive part 62 to the second diode D2 is smaller than the current value of a current I₁ refluxed from the conductive part 62 to the first diode D1. As a result, it is possible to make the current density of the second diode D2 less than that of the first diode D1. The resistor R1 is connected, for example, between the anode of the second diode D2 and the anode of the first diode D1. The current I₁ is a current flowing in the forward direction of the first diode D1, and the current I₂ is a current flowing in the forward direction of the second diode D2.

By monitoring a sense voltage Vse generated as a result of a current flowing through the resistor R1, for example, the temperature detection circuit 50 detects the differential voltage ΔVF between the forward voltage VF1 of the first diode D1 and the forward voltage VF2 of the second diode D2. The sense voltage Vse is, for example, a voltage generated between the two ends of the resistor R1 as a result of the current I₂ flowing through the resistor R1.

Assuming the voltage at the emitter terminal E (in other words, the connection point “d”) as a reference voltage, the collector voltage Vm at the collector terminal C (in other words, the connection point “a”) is equal to −VF1 (Vm=−VF1) while the first diode D1 and the second diode D2 are energized. Therefore, while the first diode D1 and the second diode D2 are energized, the sense voltage Vse (in other words, the voltage at the connection point “b”) is expressed by:

Vse=Vm+VF2=VF2−VF1<0

Therefore, in the temperature detection circuit 50, it is possible to detect the differential voltage ΔVF between the forward voltage VF1 and the forward voltage VF2 by monitoring the sense voltage Vse generated through the resistor R1 inserted in the path 31 in series. That is, the resistor R1 has both a function as a limiting resistor to reduce the current density of the second diode D2 and a function as a detecting resistor for detecting the differential voltage ΔVF.

Relations between the forward voltage VF of the diode and the forward current I flowing through the diode can be expressed by FORMULA 1 using Shockley's diode formula, where Is denotes a reverse saturated current and V_{T} denotes a thermal voltage.

$$\begin{matrix}I = Is \times \{ Exp ( \frac{VF}{{V}_{T}} ) - 1 \} & FORMULA 1 \\ I \approx Is \times Exp ( \frac{VF}{{V}_{T}} ) & FORMULA 2 \\ VF = {V}_{T} Ln ( \frac{I}{Is} ) & FORMULA 3\end{matrix}$$

Note that “−1” in the bracket { } of FORMULA 1 is sufficiently smaller in comparison to “Exp(VF/V_{T})”, and therefore, can be ignored. As a result, FORMULA 2 is acquired. Then, FORMULA 2 is deformed, and thus, the forward voltage VF can be expressed by FORMULA 3.

Also, the sense voltage Vse is coincident with “VF2−VF1” as mentioned above. Therefore, the sense voltage Vse can be expressed by FORMULA 5 using FORMULA 3 and FORMULA 4.

$$\begin{matrix} {V}_{T} = \frac{kT}{q} & FORMULA 4 \\ Vse = VF 2 - VF 1 = {V}_{T} Ln ( \frac{{I}_{2}}{{Is}_{2}} ) - {V}_{T} Ln ( \frac{{I}_{1}}{{Is}_{1}} ) = \frac{kT}{q} Ln ( \frac{{I}_{2}}{{I}_{1}} \times \frac{{Is}_{1}}{{Is}_{2}} ) & FORMULA 5\end{matrix}$$

There, k denotes the Boltzmann's constant; T denotes the absolute temperature; q denotes the elementary electric charge; I₁ denotes the forward current flowing through the first diode D1; I₂ denotes the forward current flowing through the second diode D2; Is₁ denotes the reverse saturated current of the first diode D1; and Is₂ denotes the reverse saturated current of the second diode D2.

A reverse saturated current Is is in proportion to the junction area of a diode. Therefore, (Is₁/Is₂) denotes a junction area ratio between the first diode D1 and the second diode D2, i.e., the size ratio S. Therefore, as a result of FORMULA 5 being deformed, the absolute temperature T can be expressed by FORMULA 6.

$$T = \frac{Vse \times q}{k} Ln ( \frac{{I}_{1}}{{I}_{2}} \times \frac{1}{S} ) = \frac{Vse \times q}{k} Ln ( \frac{n}{S} ) \qquad FORMULA 6$$

There, n (=I₁/I₂) denotes the ratio of the current I₁ flowing through the first diode D1 and the current I₂ flowing through the second diode D2 (=sense ratio) (where n>S).

Thus, q and k are known values, and also, n and S are known design values. Therefore, the temperature detection circuit 50 is capable of estimating the absolute temperature T according to FORMULA 6 by detecting the sense voltage Vse.

The temperature detection circuit 50 outputs, for example, temperature information according to the detected sense voltage Vse. As the temperature information, for example, the detection value of the differential voltage ΔVF (in other words, the sense voltage Vse), the estimation value of the absolute temperature T, or so, can be cited.

The driving apparatus 1 includes a gate driving circuit 40, for example. The gate driving circuit 40 turns on and off the transistor S1 according to a driving signal. The driving signal is a command signal for turning on and off the transistor S1 and is a signal (for example, a pulse-width modulation signal) supplied by an external apparatus, such as a microcomputer, which is a host apparatus of the driving apparatus.

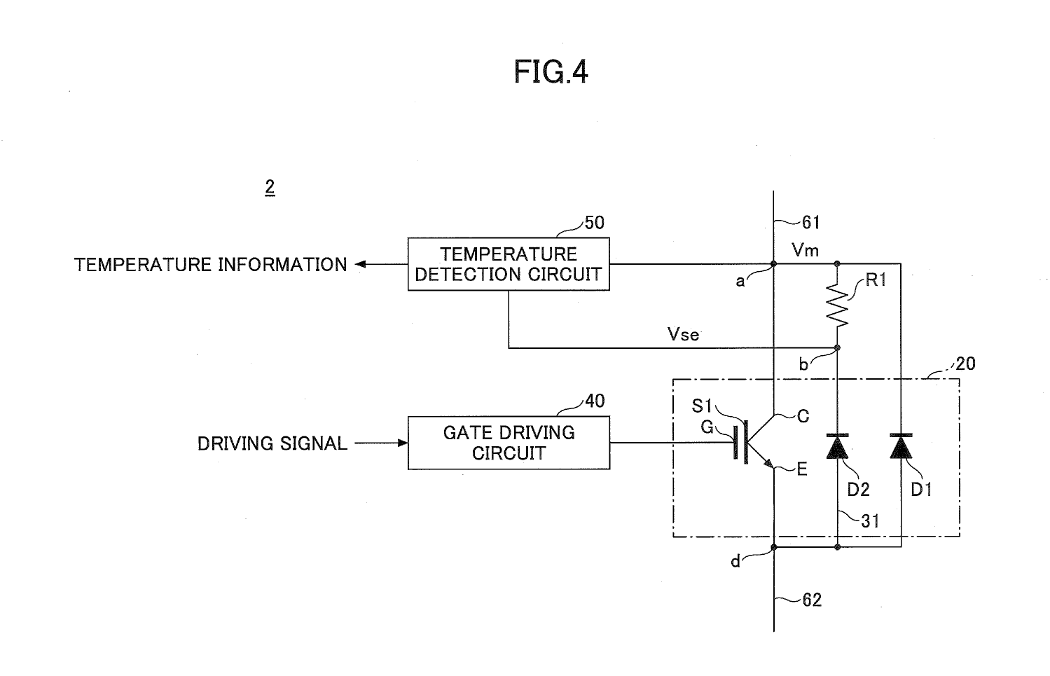

FIG. 4 illustrates a configuration of a driving apparatus 2 which is another example of a semiconductor apparatus. Description of the same configuration and advantageous effects as those of the above-described embodiment will be omitted. As shown in FIG. 4, the resistor R1 inserted into the path 31 in series can be connected between the cathode of the second diode D2 and the cathode of the first diode D1.

Assuming the voltage at the emitter terminal E (in other words, the connection point “d”) as a reference voltage, the sense voltage Vse can be expressed by, in the case of FIG. 4, while the first diode D1 and the second diode D2 are energized,

Vse=−VF2−(−VF1)=VF1−VF2>0

Therefore, the temperature detection circuit 50 is capable of detecting the differential voltage ΔVF between the forward voltage VF1 and the forward voltage VF2 by monitoring the sense voltage Vse generated through the resistor R1 inserted into the path 31 in series. That is, the resistor R1 has both a function as a limiting resistor for reducing the current density of the second diode D2 and a function as a detecting resistor for detecting the differential voltage ΔVF.

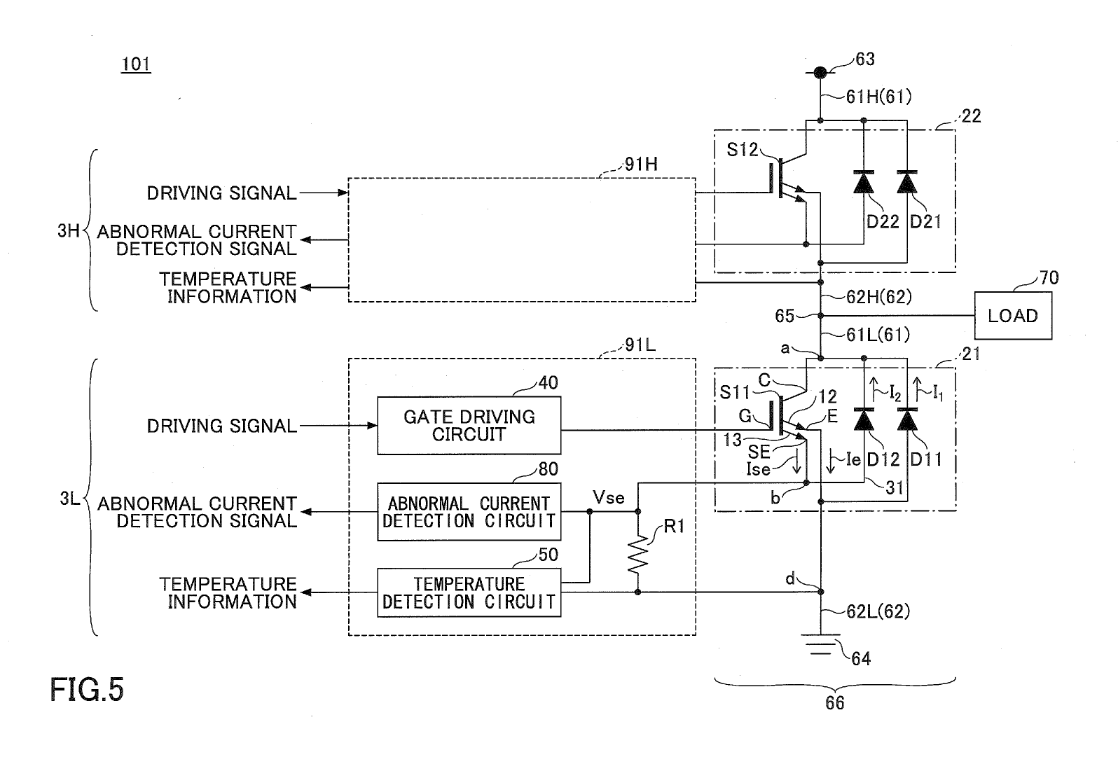

FIG. 5 illustrates a configuration of one example of a power conversion apparatus 101 including a plurality of semiconductor apparatuses. Description of the same configuration and advantageous effects as those of the above-described embodiments will be omitted.

The power conversion apparatus 101 includes two driving apparatuses 3L and 3H, and includes an arm circuit 66 where transistors provided on a high side and a low side, respectively, of an intermediate node 65 to which an inductive load 70 is connected are connected in series. When the power conversion apparatus 101 is used as an inverter to drive a three-phase motor, the power conversion apparatus 101 includes three of the arm circuits 66 provided in parallel, the number (three) of which is the same as the number of phases of the three-phase motor.

A conductive part 61H connected to the high-side transistor S12 is conductively connected to a higher electric potential power source part 63. A conductive part 62H connected to the transistor S12 is indirectly connected to a lower electric potential power source part 64 via the low-side transistor S11 or the load 70. On the other hand, a conductive part 62L connected to the low-side transistor S11 is conductively connected to the lower electric potential power source part 64. A conductive part 61L connected to the transistor S11 is indirectly connected to the higher electric potential power source part 63 via the transistor S12 or the load 70.

Each of the driving apparatuses 3L and 3H is one example of a semiconductor apparatus, and the driving apparatuses 3L and 3H have the same circuit configurations as one another. As a result, detailed description of the driving apparatus 3L below will also be applicable to the driving apparatus 3H.

The driving apparatus 3L includes the transistor S11 as one example of a switching device. The transistor S11 is an insulated-gate voltage-controlled semiconductor device having a current sense function, and has the gate terminal G, the collector terminal C, the emitter to/urinal E and a sense emitter terminal SE.

The gate terminal G is a control terminal connected to, for example, the gate driving circuit 40 of a control circuit 91L. The collector terminal C is a first main terminal connected to, for example, a connection point “a”, and connected to the conductive part 61L via the connection point “a”. The emitter terminal E is a second main terminal connected to, for example, a connection point “d”, and connected to the conductive part 62L via the connection point “d”. The sense emitter terminal SE is a sense terminal connected to, for example, a connection point “b”, and connected to the temperature detection circuit 50 and an abnormal current detection circuit 80 via the connection point “b”.

The transistor S11 includes a main transistor 12 and a sense transistor 13. The main transistor 12 and the sense transistor 13 are switching devices such as IGBTs. The sense transistor 13 is connected to the main transistor 12 in parallel. Each of the main transistor 12 and the sense transistor 13 can include a plurality of cell transistors.

The respective gate electrodes of the main transistor 12 and the sense transistor 13 are control electrodes connected to the gate terminal G of the transistor S11 in common. The respective collector electrodes of the main transistor 12 and the sense transistor 13 are first main electrodes connected to the collector terminal C of the transistor S11 in common. The emitter electrode of the main transistor 12 is a second main electrode connected to the emitter terminal E of the transistor S11. The sense emitter electrode of the transistor 13 is a sense electrode connected to the sense emitter terminal SE of the transistor S11.

The main transistor 12 is one example of a switching device. The sense transistor 13 is one example of a sense switching device generating a current that is in accordance with a current flowing through the main transistor 12 and a sense device through which the greater current flows as the current flowing through the main transistor 12 is greater. The sense transistor 13 outputs, for example, a sense current Ise in proportion to a main current Ie flowing through the main transistor 12.

For example, a collector current flowing from the collector terminal C into the transistor S11 is divided into the main current Ie flowing through the main transistor 12 and the sense current Ise flowing through the sense transistor 13 in a sense ratio “m”. The sense current Ise is a current flowing at the sense ratio “m” according to the main current Ie, and a current reduced in its current value by the sense ratio “m” from the main current Ie. The sense ratio “m” is determined, for example, according to the ratio between the area of the emitter electrode of the main transistor 12 and the area of the sense emitter electrode of the sense transistor 13.

The main current Ie flows through the collector electrode and the emitter electrode of the main transistor 12 and is output from the emitter terminal E. The main current Ie that is output from the emitter terminal E then flows through the conductive part 62L via the connection point “d”. The main current Ie is a current in a direction reverse to a diode current I₁ flowing through a main diode D11 in its forward direction.

The sense current Ise flows through the collector electrode and the sense emitter electrode of the sense transistor 13 and is output from the sense emitter terminal SE. The sense current Ise that is output from the sense emitter terminal SE then flows through the conductive part 62L via the resistor R1 and the connection point “d”. The sense current Ise is a current in a direction reverse to a sense diode current I₂ flowing through a sense diode D12 in its forward direction.

The driving apparatus 3L includes the main diode D11 and the sense diode D12. The main diode D11 is one example of a first reflux diode connected to the main transistor 12 in reverse parallel.

The sense diode D12 is one example of a second reflux diode inserted into the path 31 in series which is connected to the main diode D11 in parallel. The sense diode D12 is one example of a sense diode generating a sense current that is in accordance with a current flowing through the main diode D11, and a sense device through which the greater current flows as the current flowing through the main diode 11 is greater. The sense diode D12 outputs, for example, the sense diode current I₂ that is in proportion to the diode current I₁ flowing through the main diode D11.

The sense diode current I₂ is a current flowing at a sense ratio “n” according to the diode current I₁, and a current reduced in its current value by the sense ratio “n” from the diode current I₁. The sense diode current I₂ is a current flowing in the forward direction of the sense diode D12.

The anode of the sense diode D12 is connected to the connection point “b” to which the sense emitter terminal SE is connected, and is a p-type electrode connected to the voltage detection part of the temperature detection circuit 50 via the connection point “b”. The cathode of the sense diode D12 is connected to the connection point “a” to which the collector terminal C is connected, and is an n-type electrode connected to the conductive part 61 via the connection point “a”.

The temperature detection circuit 50 detects the differential voltage ΔVF between the forward voltage VF1 of the main diode D11 and the forward voltage VF2 of the sense diode D12 by, for example, monitoring the negative sense voltage Vse generated as a result of the sense diode current I₂ flowing through the resistor R1. In this case, the sense voltage Vse is, for example, a voltage generated between the two ends of the resistor R1 as a result of the sense diode current I₂ flowing through the resistor R1.

While the main diode D11 and the sense diode D12 are energized, the temperature detection circuit 50 is capable of estimating the absolute temperature T through, for example, detecting the differential voltage ΔVF by monitoring the negative sense voltage Vse generated as a result of the sense diode current I₂ flowing through the resistor R1.

The driving apparatus 3L includes the abnormal current detection circuit 80. The abnormal current detection circuit 80 is one example of an abnormality detection part detecting abnormality in the main current Ie flowing through the main transistor 12 based on the positive sense voltage Vse generated as a result of the sense current Ise passing through the resistor R1. In this case, the sense voltage Vse is, for example, the voltage generated between the two ends of the resistor R1 as a result of the sense current Ise flowing through the resistor R1.

While the transistor S11 is being energized, the abnormal current detection circuit 80 is capable of determining whether the main current Ie is an abnormal current (for example, an overcurrent or a short-circuit current) by, for example, comparing the positive sense voltage Vse generated as a result of the sense current Ise flowing through the resistor R1 and a predetermined reference voltage. For example, the abnormal current detection circuit 80 determines that the main current Ie is an overcurrent when the positive sense voltage Vse exceeds the predetermined reference voltage.

The abnormal current detection circuit 80 outputs an abnormal current detection signal according to the detected sense voltage Vse. As specific examples of the abnormal current detection signal, a detection value of the differential voltage ΔVF (in other words, the sense voltage Vse) and a determination signal for an abnormal current can be cited, for example.

When abnormality of the main current Ie is detected by the abnormal current detection circuit 80, the transistor S11 is turned off by the gate driving circuit 40, for example. As a result of the transistor S11 being turned off, the main transistor 12 and the sense transistor 13 are turned off, and thereby, it is possible to cut the abnormal flow of the main current Ie.

Thus, the sense emitter terminal SE has both a function for temperature detection and a function for current abnormality detection, and therefore, it is possible to share the same terminals as both temperature detection terminals and current abnormality detection terminals. Also, as a result of sharing the same terminals as both temperature detection terminals and current abnormality detection terminals, it is possible to share also wires required to connect the terminals.

Further, when the diode current I₁ refluxed from the low-side main diode D11 to the load 70 via the intermediate node 65 flows, the temperature detection circuit 50 of the control circuit 91L is capable of detecting the temperature of the low-side transistor S11, for example. On the other hand, the abnormal current detection circuit 80 of the control circuit 91L is capable of detecting abnormality of the main current Ie flowing into the low-side main transistor 12 when the main current Ie flows from the load 70 into the low-side main transistor 12 via the intermediate node 65. As a result of the main diode D11 and the sense diode D12 being installed on a chip 21 on which the low-side main transistor 12 and the sense transistor 13 are installed, it is possible to increase the advantageous effect of detecting the temperature of the low-side transistor S11 with high accuracy.

On the other hand, the temperature detection circuit 50 of the control circuit 91H is capable of detecting the temperature of the high-side transistor S12 when, for example, the diode current I₁ refluxed from the load 70 to the high-side main diode D21 via the intermediate node 65 flows. On the other hand, the abnormal current detection circuit 80 of the control circuit 91H is capable of detecting abnormality of the main current Ie flowing out from the high-side main transistor 12 when the main current Ie flowing out from the high-side main transistor 12 to the load 70 via the intermediate node 65 flows. As a result of the main diode D21 and the sense diode D22 being installed on a chip 22 on which the high-side main transistor 12 and the sense transistor 13 are installed, it is possible to increase the advantageous effect of detecting the temperature of the high-side transistor S12 with high accuracy.

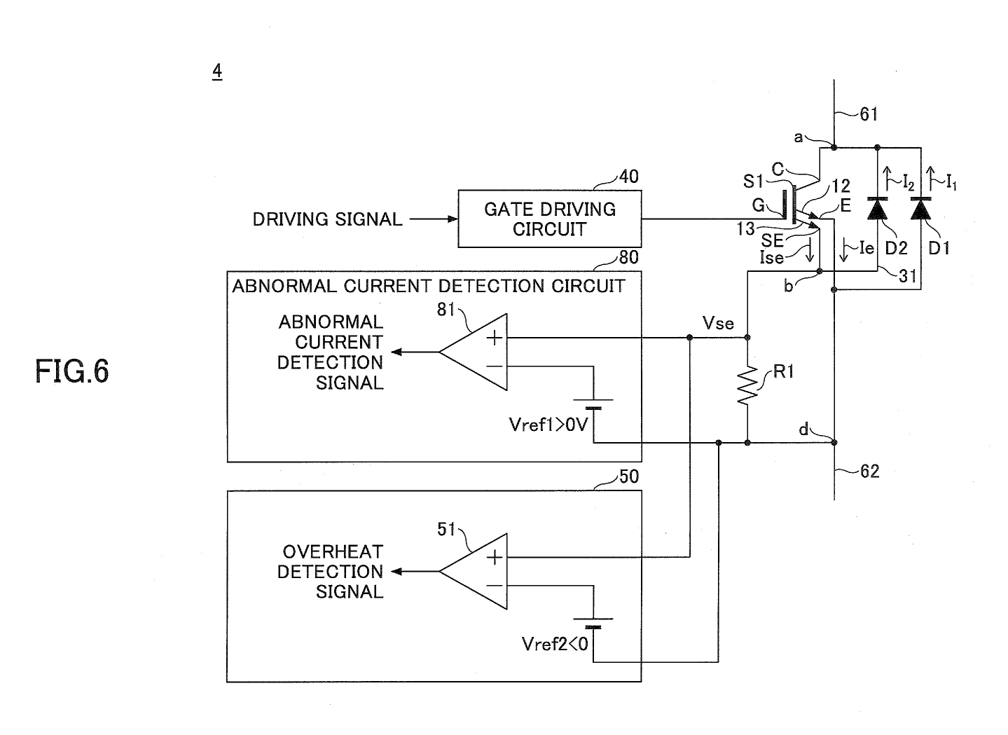

FIG. 6 illustrates a configuration of a driving apparatus 4 that is yet another example of a semiconductor apparatus. Description of the same configuration and advantageous effects as those of the above-described embodiments will be omitted. Also the driving apparatus 4 can be applied to a power conversion apparatus such as that shown in FIG. 5.

As a result of the sense current Ise flowing through the resistor R1, the sense voltage Vse according to the magnitude of the main current Ie is generated between the two ends of the resistor R1. For example, the abnormal current detection circuit 80 is capable of detecting the magnitude of the main current Ie by detecting the positive voltage value of the sense voltage Vse.

The abnormal current detection circuit 80 can also have a comparator 81, for example, as shown in FIG. 6. The comparator 81 compares the sense voltage Vse with a positive reference voltage Vref1 and outputs the abnormal current detection signal that is in accordance with the comparison result. The comparator 81 determines that an overcurrent (or a short-circuit current) flows through the transistor S1 when detecting that the sense voltage Vse is greater than the positive reference voltage Vref1, and outputs the abnormal current detection signal of a high level.

When the abnormal current detection signal of the high level is output from the abnormal current detection circuit 80, the transistor S1 is turned off by the gate driving circuit 40, for example. As a result of the transistor S1 being turned off, the main transistor 12 and the sense transistor 13 are turned off, and thus, it is possible to cut the abnormal flow of the main current Ie.

On the other hand, as a result of the sense diode current I₂ flowing through the resistor R1, the sense voltage Vse according to the magnitude of the diode current I₁ is generated between the two ends of the resistor R1. For example, the temperature detection circuit 50 is capable of detecting the temperatures of the first diode D1 and the second diode D2 or the temperatures of the main transistor 12 and the sense transistor 13 by detecting the negative voltage value of the sense voltage Vse. Also, for example, the temperature detection circuit 50 can detect the magnitude of the diode current I₁ by detecting the negative voltage value of the sense voltage Vse.

The temperature detection circuit 50 can have, for example, a comparator 51, as shown in FIG. 6. The comparator 51 compares the sense voltage Vse with a negative reference voltage Vref2, and outputs an overheat detection signal that is in accordance with the comparison result. The comparator 51 determines that the first diode D1 or the main transistor 12 is abnormally heated when detecting that the sense voltage Vse is less than the negative reference voltage Vref2, and outputs an overheat detection signal of a low level.

When the overheat detection signal of the low level is output by the temperature detection circuit 50, the transistor S1 is turned off by the gate driving circuit 40, for example. As a result of the transistor S1 being turned off, the main transistor 12 and the sense transistor 13 are turned off, and thus, it is possible to avoid an abnormal temperature increase of the first diode D1 or the main transistor 12.

Thus, the resistor R1 and the sense emitter terminal SE can have both a function of abnormality detection of the main current Ie and a function of temperature detection, and therefore, it is possible to miniaturize and reduce the cost of the driving apparatus 4.

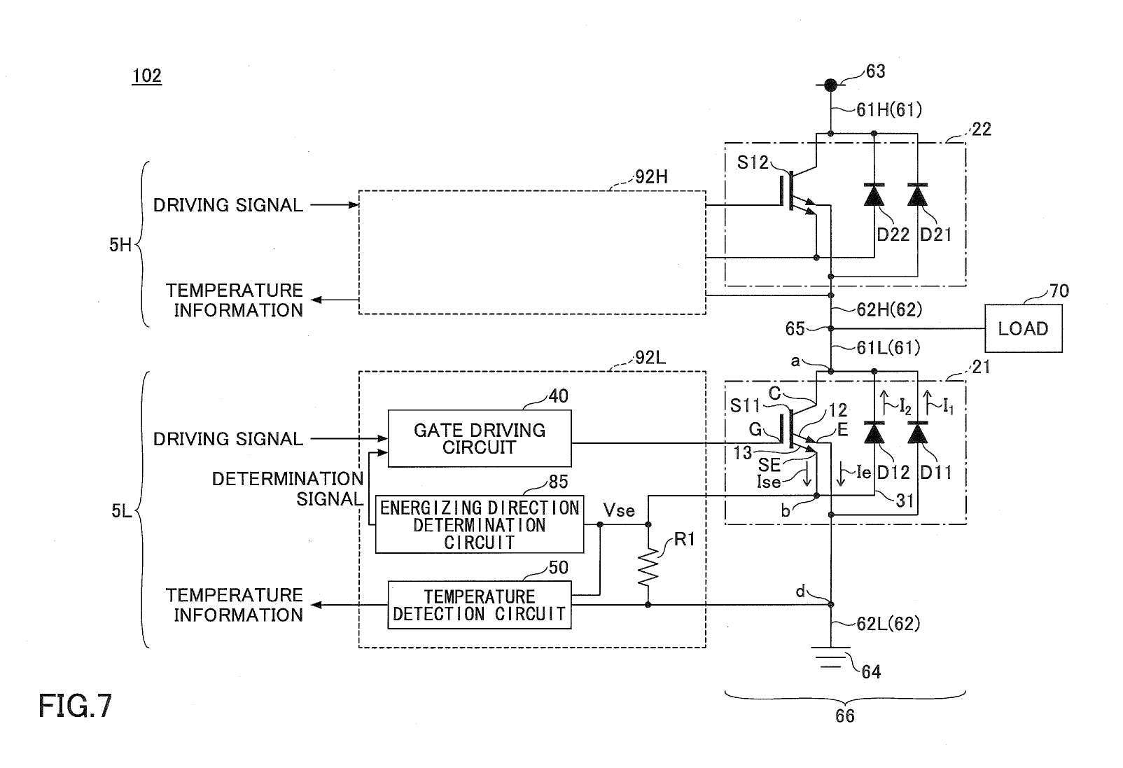

FIG. 7 illustrates a configuration of another example of a power conversion apparatus 102 including a plurality of semiconductor apparatuses. Description of the same configuration and advantageous effects as those of the above-described embodiments will be omitted.

Each of driving apparatuses 5L and 5H is one example of a semiconductor apparatus, and the driving apparatuses 5L and 5H have the same circuit configurations as one another. Thus, detailed description of the driving apparatus 5L below is also applicable to the driving apparatus 5H.

The transistor S11 is, for example, diode built-in IGBTs where the main transistor 12, the sense transistor 13, the main diode D11 and the sense diode D12 are installed on a common chip 21. The diode built-in IGBTs have a configuration where the electrodes are shared as the anode electrodes of the diodes and the emitter electrodes of IGBTs and the electrodes are shared as the cathode electrodes of the diodes and the collector electrodes of the IGBTs. The diode built-in IGBTs are also referred to as reverse conducting IGETs (RC-IGBTs). The sense emitter terminal SE is a sense terminal that is connected to, for example, the connection point “b”, and is connected to the temperature detection circuit 50 and an energizing direction determination circuit 85 via the connection point “b”.

The energizing direction determination circuit 85 is one example of a turning-off control part maintaining a turned-off state of the main transistor 12 based on the sense voltage Vse generated as a result of the sense diode current I₂ refluxed to the sense diode D12 flowing passing through the resistor R1. The energizing direction determination circuit 85 is capable of determining that the transistor S11 is being energized when detecting the positive sense voltage Vse and determining that the main diode D11 is being energized when detecting the negative sense voltage Vse.

The gate driving circuit 40 maintains the turned-off state of the transistor S11 even when the driving signal for turning on the transistor S11 is supplied while the determination signal indicating that the main diode D11 is being energized is input. Thereby, it is possible to avoid switching the main transistor 12 and the sense transistor 13 from the turned-off states to the turned-on states while the diode current I₁ is flowing. Also, it is possible to avoid an increase of losses in the main diode D11 and the sense diode D12 due to turning on the main transistor 12 and the sense transistor 13 while the diode current I₁ is flowing.

The temperature detection circuit 50 detects the differential voltage ΔVF between the forward voltage VF1 of the main diode D11 and the forward voltage VF2 of the sense diode D12 by, for example, monitoring the negative sense voltage Vse generated as a result of the sense diode current I₂ flowing through the resistor R1. While the main diode D11 and the sense diode D12 are being energized, the temperature detection circuit 50 is capable of estimating the absolute temperature T through, for example, detecting the differential voltage ΔVF by monitoring the negative sense voltage Vse generated as a result of the sense diode current I₂ flowing through the resistor R1.

The energizing direction determination circuit 85 can have a function as an abnormality detection part (for example, the function of the above-described abnormal current detection circuit 80) detecting abnormality of the main current Ie flowing through the main transistor 12 based on the positive sense voltage Vse generated as a result of the sense current Ise passing through the resistor R1.

Thus, the semiconductor apparatuses have been described in the embodiments. However, the present invention is not limited to these embodiments. Various modifications and improvements such as combinations or replacements with parts or all of other embodiments can be made without departing from the scope of the present invention.

For example, a semiconductor apparatus according to an embodiment can be a semiconductor device having a configuration formed by an integrated circuit(s) or a semiconductor device having a configuration formed by discrete components.

Also, transistors used in a semiconductor apparatus according to an embodiment can be other switching devices than IGBTs, for example, n-channel or p-channel Metal Oxide Semiconductor Field Effect Transistors (MOSFETs), or npn-type or pnp-type bipolar transistors. When MOSFETs are used, the above descriptions can be read in such a manner that “collectors” are replaced by “drains” and “emitters” are replaced by “sources”. When bipolar transistors are used, the descriptions can be read in such a manner that “gates” are replaced by “bases”.

The above-described embodiments illustrate cases where the current density of the second reflux diode is less than the current density of the first reflux diode. However, it is also possible to detect the temperature with high accuracy also in a case where the current density of the first reflux diode is less than the current density the second reflux diode.

For example, in FIG. 1, it is possible to make the current density of the first diode D1 be less than the current density the second diode D2 by changing the connection of the resistor R1 from the connection with the second diode D2 in series to the connection with the first diode D1 in series. Similarly, in FIG. 5, for example, it is possible to make the current density of the main diode D11 be less than the current density the sense diode D12 by changing the connection of the resistor R1 from the connection with the sense diode D12 in series to the connection with the main diode D11 in series when a necessary condition such as the abnormal current detection circuit 80 is not included is met.

According to an embodiment, because a first reflux diode and a second reflux diode are heat generation sources, as a result of the forward voltages of the heat generation sources themselves being used for temperature detection, it is possible to detect the temperature with high accuracy. Also, according to the embodiment, when the current density of the first reflux diode and the current density of the second reflux diode are different from one another, the temperature dependency of the above-mentioned differential voltage is not easily reduced in comparison to the temperature dependency of the forward voltage of a sole reflux diode. Thus, it is possible to detect the temperature with high accuracy.

The present application is based on and claims the benefit of priority of Japanese Priority Application No. 2014-114209, filed on Jun. 2, 2014, the entire contents of which are hereby incorporated herein by reference.

What is claimed is:

1. A semiconductor apparatus comprising:
a switching device;
a first reflux diode connected in reverse parallel with the switching device;
a current path connected in parallel with the first reflux diode;
a second reflux diode inserted into the current path in series; and
a temperature detection part configured to detect a temperature based on a differential voltage between a forward voltage of the first reflux diode and a forward voltage of the second reflux diode, wherein
a current density of the first reflux diode and a current density of the second reflux diode are different from one another.

2. The semiconductor apparatus as claimed in claim 1, wherein
the current density of the second reflux diode is less than the current density of the first reflux diode.

3. The semiconductor apparatus as claimed in claim 2, wherein
the temperature detection part is configured to detect the differential voltage by monitoring a voltage generated as a result of a current flowing through a resistor inserted into the current path in series.

4. The semiconductor apparatus as claimed in claim 3, wherein
the resistor is connected between an anode of the second reflux diode and an anode of the first reflux diode.

5. The semiconductor apparatus as claimed in claim 4, comprising:
a sense switching device configured to generate a sense current that is in accordance with a current flowing through the switching device; and
an abnormality detection part configured to detect abnormality in the current flowing through the switching device based on a sense voltage generated as a result of the sense current flowing through the resistor.

6. The semiconductor apparatus as claimed in claim 4, comprising:
a turning-off control part configured to maintain a turned-off state of the switching device based on a sense voltage generated as a result of a reflux current flowing through the second reflux diode passing through the resistor.

7. The semiconductor apparatus as claimed in claim 5, comprising:
a turning-off control part configured to maintain a turned-off state of the switching device based on a sense voltage generated as a result of a reflux current flowing through the second reflux diode passing through the resistor.

8. The semiconductor apparatus as claimed in claim 1, wherein
the first reflux diode and the second reflux diode are installed on a chip on which the switching device is installed.

9. The semiconductor apparatus as claimed in claim 2, wherein
the first reflux diode and the second reflux diode are installed on a chip on which the switching device is installed.

10. The semiconductor apparatus as claimed in claim 3, wherein
the first reflux diode and the second reflux diode are installed on a chip on which the switching device is installed.

11. The semiconductor apparatus as claimed in claim 4, wherein
the first reflux diode and the second reflux diode are installed on a chip on which the switching device is installed.

12. The semiconductor apparatus as claimed in claim 5, wherein
the first reflux diode and the second reflux diode are installed on a chip on which the switching device is installed.

13. The semiconductor apparatus as claimed in claim 6, wherein
the first reflux diode and the second reflux diode are installed on a chip on which the switching device is installed.

14. The semiconductor apparatus as claimed in claim 7, wherein
the first reflux diode and the second reflux diode are installed on a chip on which the switching device is installed.
